(19) United States
(12) Patent Application Publication
(10) Pub. No.: US 2025/0240222 A1
(43) Pub. Date: Jul. 24, 2025

(54) Self-optimizing Networks Using Speed Test Results

(71) Applicant: Charter Communications Operating, LLC, St. Louis, MO (US)

(72) Inventors: Roger G. STAFFORD, Thornton, CO (US); Jay T. LIEW, Parker, CO (US); Justin STILES, Thornton, CO (US)

(21) Appl. No.: 18/418,633

(22) Filed: Jan. 22, 2024

(51) Int. Cl. H04L 41/5009; H04L 41/16; H04L 43/0888

(52) U.S. Cl. CPC H04L 41/5009; H04L 41/16; H04L 43/0888

(57) ABSTRACT

Various embodiments describe methods, systems, and devices for self-improving networks. Embodiments may include setting network parameter settings for a network hardware deployed in an operable network, testing performance of the network hardware having the network parameter settings, storing results of testing the network hardware, the network parameter settings, and a network condition of the network hardware in association with each other, training a machine learning model for classifying network parameter settings for the network hardware based on network conditions for the network hardware for at least achieving a performance threshold of the network hardware using the results of testing the network hardware, the network parameter settings, and the network condition as training inputs to the machine learning model, and storing a result of the machine learning model in association with the network parameter settings and the network condition.

### BACKGROUND

Multi-system operators strive to improve operation of networks. Network hardware updates through replacement and/or addition may achieve operational improvements of the networks but are expensive and slow to implement. Therefore, existing network hardware may constrain network operation. The network hardware capabilities may be constrained by network hardware configuration, which is usually based on a combination of some initial research and guidance from specification developers. The network hardware configurations are based on what is known to work on either a set of test network hardware or in a lab environment. However, in the field, the network hardware configurations may work well for some network hardware implementations, but not for all network hardware implementations.

### SUMMARY

Various aspects include methods for self-improving networks implemented by a processing system. Aspects may include setting at least two first network parameter settings for a first network hardware deployed in an operable network, testing performance of the first network hardware having the at least two first network parameter settings, storing results of testing the first network hardware having the at least two first network parameter settings and at least one first network condition of the first network hardware in association with each other, training a machine learning model for classifying network parameter settings for the first network hardware based on one or more network conditions for the first network hardware for at least achieving a performance threshold of the first network hardware using the stored results of testing the first network hardware having the at least two first network parameter settings, the at least two first network parameter settings, and the at least one first network condition as training inputs to the machine learning model, and storing at least a first result of the machine learning model classifying the network parameter settings for the first network hardware based on the one or more network conditions for the first network hardware for at least achieving the performance threshold of the first network hardware in association with the at least two first network parameter settings and the at least one first network condition of the first network hardware.

In some aspects, setting the at least two first network parameter settings for the first network hardware may include setting the at least two first network parameter settings for the first network hardware for the at least one first network condition using the at least two first network parameter settings for the first network hardware stored in association with the at least one first network condition and the first result of the machine learning model classifying the network parameter settings for the first network hardware based on the one or more network conditions for the first network hardware for at least achieving the performance threshold of the first network hardware.

Some aspects may further include setting at least two second network parameter settings for the first network hardware, testing performance of the first network hardware having the at least two second network parameter settings, storing results of testing the first network hardware having the at least two second network parameter settings, the at least two second network parameter settings, and at least one second network condition of the first network hardware in association with each other, training the machine learning model for classifying the network parameter settings for the first network hardware based on the one or more network conditions for the first network hardware for at least achieving the performance threshold of the first network hardware using the results of testing the first network hardware having the at least two second network parameter settings, the at least two second network parameter settings, and the at least one second network condition as training inputs to the machine learning model, and storing at least a second result of the machine learning model classifying the network parameter settings for the first network hardware based on the one or more network conditions for the first network hardware for at least achieving the performance threshold of the first network hardware in association with the at least two second network parameter settings and the at least one second network condition of the first network hardware.

In some aspects, the at least two second network parameter settings include at least one of the at least two first network parameter settings, and the at least one second network condition includes at least one of the at least one first network condition.

Some aspects may further include setting at least two second network parameter settings for a second network hardware deployed in the operable network and that is different from the first network hardware, testing performance of the second network hardware having the at least two second network parameter settings, storing results of testing the second network hardware having the at least two second network parameter settings, the at least two second network parameter settings, and at least one second network condition of the second network hardware in association with each other, training the machine learning model for classifying network parameter settings for the second network hardware based on the one or more network conditions for the second network hardware for at least achieving a performance threshold of the second network hardware using the results of testing the second network hardware having the at least two second network parameter settings, the at least two second network parameter settings, and the at least one second network condition as training inputs to the machine learning model, and storing at least a second result of the machine learning model classifying the network parameter settings for the second network hardware based on the one or more network conditions for the second network hardware for at least achieving the performance threshold of the second network hardware in association with the at least two second network parameter settings and the at least one second network condition of the second network hardware.

In some aspects, testing the performance of the first network hardware having the at least two first network parameter settings may include testing throughput speed of the first network hardware having the at least two first network parameter settings.

In some aspects, the performance threshold of the first network hardware is configured for indicating how the first result of the machine learning model classifying the network parameter settings for the first network hardware based on the one or more network conditions for the first network hardware for at least achieving the performance threshold of the first network hardware compares with at least one other result of the machine learning model classifying the network parameter settings for the first network hardware based on the one or more network conditions for the first network hardware for at least achieving the performance threshold of the first network hardware.

Further aspects may include a computing device having a processing system configured to perform one or more operations of the methods summarized above. Further aspects may include a non-transitory processing system-readable storage medium having stored thereon processing system-executable instructions configured to cause a processing system of a computing device to perform operations of the methods summarized above. Further aspects include a computing device having means for performing functions of the methods summarized above.

### BRIEF DESCRIPTION OF THE DRAWINGS

The accompanying drawings, which are incorporated herein and constitute part of this specification, illustrate exemplary embodiments of the claims and together with the general description given above and the detailed description given below, serve to explain the features of the claims.

FIG. 1 is a schematic diagram conceptually illustrating an operational network in accordance with various embodiments.

FIG. 2 is a block diagram illustrating a network hardware configuration processing system configured with executable modules in accordance with various embodiments.

FIG. 3 is a process flow diagram illustrating embodiment methods for implementing self-improving networks suitable for use with various embodiments.

FIG. 4 is a process flow diagram illustrating embodiment methods for implementing a learning phase of self-improving networks suitable for use with various embodiments.

FIG. 5 is a process flow diagram illustrating embodiment methods for implementing an improvement phase of self-improving networks suitable for use with various embodiments.

FIG. 6 is a process flow diagram illustrating embodiment methods for implementing self-improving networks suitable for use with various embodiments.

FIGS. 7A and 7B are graph diagrams illustrating embodiment methods for implementing self-improving networks suitable for use with various embodiments.

FIG. 8 is a component diagram of an example network hardware suitable for use with various embodiments.

FIG. 9 is a component diagram of an example server suitable for use with the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include systems and methods for implementing self-improving networks. Some embodiment systems and methods may include a setting of network parameters for network hardware and testing the network hardware set with the network parameters under network conditions. In some embodiment systems and methods, the network parameters may be set on an algorithmic selection of network parameter values. In some embodiment systems and methods, the network parameters may be set on selection of stored network hardware values associated with a classification by a machine learning model as at least achieving a performance threshold of the network hardware. Some embodiment systems and methods may include training the machine learning model to classify the network parameter settings under the network conditions for at least achieving the performance threshold.

Generally, multi-system operators strive to improve operation of networks. Network hardware updates may be affected through replacement and/or addition of hardware may achieve operational improvements of the networks but are expensive and slow to implement. Therefore, existing network hardware may constrain network operation. The network hardware capabilities may be constrained by network hardware configuration, which is usually based on a combination of some initial research and guidance from specification developers. The network hardware configurations are based on what is known to work on either a set of test network hardware or in a laboratory environment. However, in the field, the network hardware configurations may work well for some network hardware implementations, but not for all network hardware implementations.

Embodiment systems and methods disclosed herein address and overcome the foregoing problems by implementing methods and devices that enable self-improving networks. The self-improvement may be achieved by identifying and using network parameters for specific network hardware and network conditions that improve network performance over previously used network parameters for similar network hardware. The methods and systems may test the network parameters for the specific network hardware and the network conditions. The embodiment systems and methods may classify the network parameters for the specific network hardware and the network conditions as at least achieving a performance threshold. A machine learning model may be configured so that classifications of different network parameters for the specific network hardware and the network conditions may be identified as whether the network performance improves using the different network parameters.

The classified network parameters for the specific network hardware and the network conditions identified as most effectively improving the network performance as compared with other classified network parameters may be used for setting the network parameters for the specific network hardware under the network conditions. In this manner, the methods and devices may enable a recursive means of improving the network performance for the specific network hardware under the network conditions. The methods and devices may be implemented for any one or more individual and/or groups of network hardware, enabling implementation of the self-improving networks at any level and/or any locations of an operational network.

The embodiment methods and devices enable broad scale improvement of operational network performance by enabling improvement to the network performance of specific network hardware at any level and/or any location of an operational network under varying network conditions. For example, network parameters settings for a type of network hardware may differ between specific ones of the type of network hardware across the operational network. The network parameters settings may differ so that the network performance of the specific ones of the type of network hardware is improved based on the testing and classification of the network parameters settings for the specific ones of the type of network hardware.

The embodiment methods and systems enable operational network performance improvement otherwise unachievable due to the vast variability and number of network parameters for the vast variability and number of network hardware and the vast variability and number of network conditions for which to account. The embodiment methods and systems may be implemented in operational networks throughout normal day-to-day operations, thereby reducing an amount of laboratory testing for determining network parameter settings of the network hardware. The embodiment methods and systems enable operational network performance improvement over static network parameters by enabling testing, classifying, and setting network parameters for varying network conditions.

The embodiment methods and systems enable operational network performance improvement over using network parameter settings suggested by initial research and guidance from specification developers. For example, most often in a testing setting, in instances in which a high value network parameter setting is found not to work, then the high value is reduced until it works. That network parameter setting value found to work may be globally applied on the inference that the value must also be good for all similar network hardware. This may lead to sub-optimal reduction on network hardware that does not need the reduced network parameter setting value. There is also the opposite case where, in a plurality of similar network systems that differ by noise and traffic conditions, an upper limit of the network parameter setting is not known because increasing the network parameter setting value is avoided to avoid increasing the number of network hardware that cannot operate with higher network parameter setting values. Hence, suggested network parameter settings are a reduced set network parameter settings configured to fit all network hardware regardless of whether other network parameters settings may improve performances of specific ones of the network hardware.

As used herein, “network hardware” may refer to any hardware of a network for which parameters that affect how the hardware functions may be set electronically, such as by a processor system, which may include one or more processors, processor cores, controllers, microcontrollers, etc. For example, network hardware may include hardware at a multi-system operator network cable-plant, headend, hub, node, etc. For example, network hardware may include a channel modulator, a frequency multiplexer, an amplifier, a tap, a splitter, a modem, a cable management termination system, a switch, a router, a quadrature amplitude modulator, etc.

As used herein, the terms “computing device”, “client device”, and “client” are used interchangeably to refer to an electronic device equipped with at least a processor, communication systems, and memory configured to receive configuration data and implement configuration settings using the received configuration data to implement capabilities. Computing devices may include, but are not limited to, any one or all of personal computers, portable computing devices, rack mounted computers, routers, modems, mobile devices, cellular telephones, smart phones, personal or mobile multi-media players, personal data assistants (PDAs), tablet computers, smart books, palm-top computers, desk-top computers, wireless electronic mail receivers, cellular telephones, gaming consoles, wireless gaming controllers, streaming media players (such as, ROKU®), DVRs, satellite or cable set top boxes, smart televisions, smart watches, smart buttons, smart appliances (such as refrigerators, ovens, washers and dryers, HVAC, water heaters, sprinklers, lighting fixtures and blubs, etc.), smart utility devices (such as water, electricity, and gas meters) smart speakers and assistants, smart home surveillance and security equipment (such as video doorbells, door locks, security video monitors, intrusion sensors, environmental sensors, etc.), smart home hubs, smart remote control devices (i.e., television remote controls with sufficient processing capabilities), smart cameras, smart pet accessories, voice over internet protocol (VOIP) telephones, printers, medical monitoring equipment and devices, embedded computers (such as in vehicles for infotainment, navigation, communication, etc.), Internet of Things (IoT) devices, and similar electronic devices which include a programmable processor and memory and circuitry for providing the functionality described herein.

The various embodiments are described herein using the term “server” to refer to any computing device capable of functioning as a server, such as communications server, a name server, a master exchange server, web server, mail server, document server, database server, route server, content server, a cloud server or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server-type functionality that can be implemented on a computing device thereby enabling it to function as a server only to the extent necessary to provide the functionality described herein.

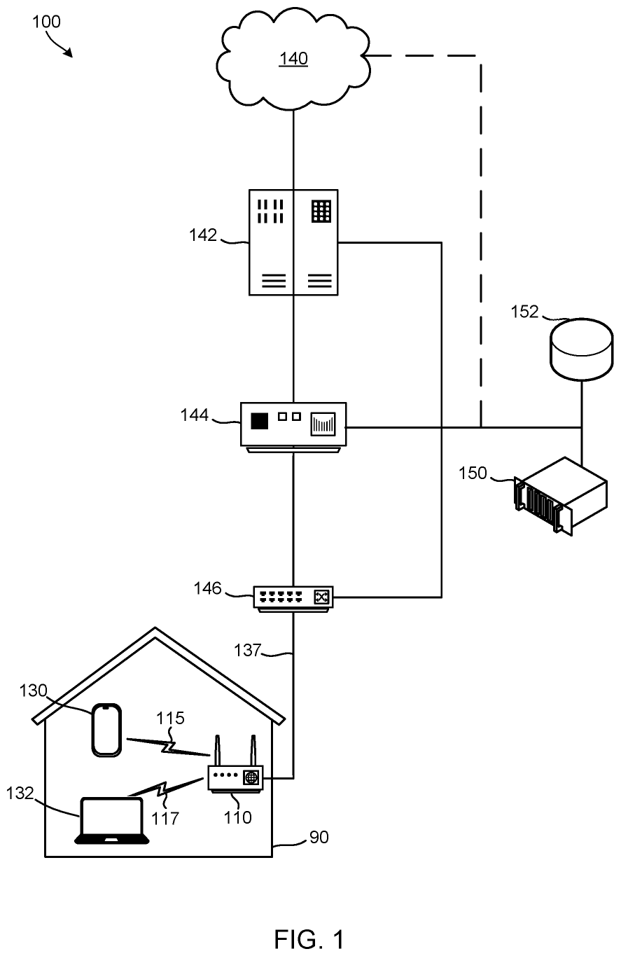

FIG. 1 illustrates an example of an operational network 100, such as an internet network, in accordance with various embodiments. With reference to FIG. 1, the operational network 100 may include various network hardware sites such as one or more headends 142, hubs 144, and/or nodes 146, any of which may be or be part of a cable-plant. Each of the network hardware sites 142, 144, 146 may be configured to provide connectivity service between one or more modems 110 and a communication network 140 (e.g., the Internet). Each of the network hardware sites 142, 144, 146 may include network hardware (not shown) to enable and control the connectivity service, such as a channel modulator, a frequency multiplexer, an amplifier, a tap, a splitter, a mode, a cable management termination system, a switch, a router, a quadrature amplitude modulator, etc. The modem 110, the network hardware sites 142, 144, 146, and the communication network 140 may be coupled by one or more wired connections 137.

Each of the network hardware sites 142, 144, 146 may be connected to remotely, such as via the communication network 140, and/or include locally a computing device 150, such as a server, and a data storage device 152, which may include, for example, a database. Any combination of the computing device 150 and the data storage device 152 may be located locally at the network hardware sites 142, 144, 146 and/or remotely to the network hardware sites 142, 144, 146. For example, both computing devices 150 and data storage devices 152 may be located locally at any of the network hardware sites 142, 144, 146. As another example, both the computing device 150 and the data storage device 152 may be located remotely from each of the network hardware sites 142, 144, 146. As yet another example, computing devices 150 may be located locally at any of the network hardware sites 142, 144, 146 and the data storage device 152 may be located remotely from each of the network hardware sites 142, 144, 146. The computing device 150 may include a processing system (not shown), such as one or more processors, processors, processor cores, controllers, microcontrollers, etc., configured to execute computer software. The data storage device 152 may be a non-volatile, processor system readable media (e.g., a magnetic, solid-state, optical, or tape, data storage device) configured to store the computer software for execution by the processing system of the computing device 150.

In some embodiments, the computer software stored by the data storage device 152 and executed by the processing system of the computing device 150 may be configured for implementing self-improving networks as described further herein. For example, the computer software may include processor system executable instructions for implementing: recognizing network conditions, selecting of network parameters, setting of network parameters, testing of network performance, storing results of the testing of network hardware, training a machine learning model for improving network performance, storing results of the machine learning model training, etc.

The computer software may be implemented by the processing system for the computing device 150 for one or more of the network hardware at one or more of the network hardware sites 142, 144, 146. In some embodiments, the computer software may be implemented and related data may be stored locally at the network hardware sites 142, 144, 146 and/or remotely to the network hardware sites 142, 144, 146 by the processing system for the computing device 150 and the data storage device 152 located locally at the network hardware sites 142, 144, 146 and/or remotely to the network hardware sites 142, 144, 146. Any combination of the

One or more modems 110 (which may include a router) may be located in one or more homes 90 or other building/area and connect a user computing device 130, 132 to the communication network 140. The modem 110 may be a network device that enables communication between networked devices, like one or more user computing devices 130, 132 and the communication network 140. The modem 110 may include the functionality of a router, which lets the user computing devices 130, 132 access the communication network 140. Alternatively, the modem 110 may be connected to and work with a separate router that connects the user computing devices 130, 132 to modem 110.

The user computing device 130, 132 may be any electronic device equipped with at least a processor, communication systems, and memory configured to receive and send data of the user computing device 130, 132 via the communication network 140. The user computing device 130, 132 may be coupled to the modem 110 by a short-range wireless connection 115, 117 (e.g., Wi-Fi, Bluetooth, etc.). The modem 110 may be coupled to the network hardware sites 142, 144, 146 and the communication network 140 by one or more wired connections 137. The user computing device 130, 132 alternatively, or additionally, may be coupled to the network hardware sites 142, 144, 146 and the communication network 140 by a long-range wireless connection (not shown).

The communication links 137 may use a variety of wireless (e.g., 5g-NR (u), LTE, Citizens Broadband Radio Service (CBRS), etc.) and/or wired networks (e.g., Ethernet, TV cable, telephony, fiber optic and other forms of physical network connections) that may use one or more communication protocols, such as Ethernet, Point-To-Point protocol, High-Level Data Link Control (HDLC), Advanced Data Communication Control Protocol (ADCCP), and Transmission Control Protocol/Internet Protocol (TCP/IP). The communications links 137 may adhere to telecommunication standards, such as Data Over Cable Service Interface Specification (DOCSIS).

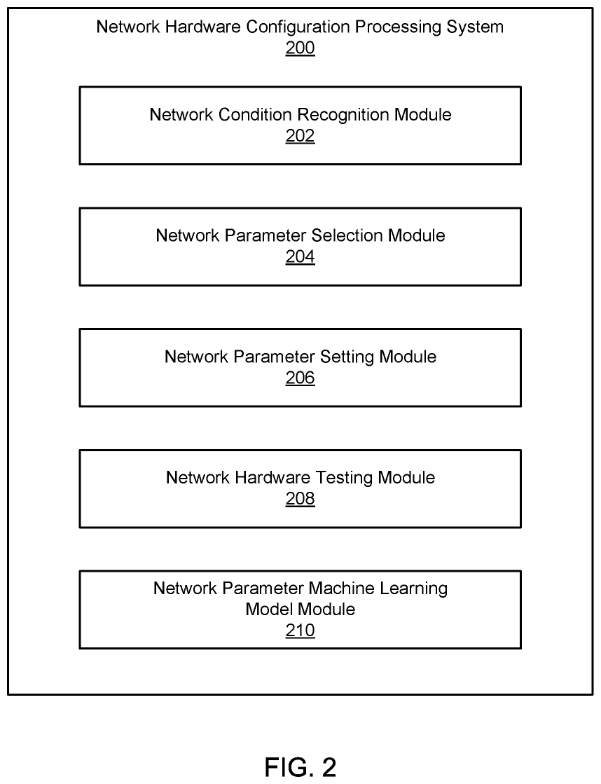

FIG. 2 illustrates a network hardware configuration processing system 200 configured with self-improving network executable modules 202-210 in accordance with various embodiments. With reference to FIGS. 1 and 2, the network hardware configuration processing system 200 (or processing system 200) may be configured with executable instructions for implementing the self-improving network executable modules 202-210. The processing system 200 may be a component of a computing device (e.g., computing device 150). The self-improving network executable modules 202-210 may be stored on and accessed by the processing system 200 from a memory device (e.g., data storage device 152).

The self-improving network executable modules 202-210 may include functionality that may be used by an administrator of an operable network (e.g., operable network 100) to improve performance of the operable network by improving performance of network hardware (e.g., network hardware at network hardware sites 142, 144, 146) of the operable network. For example, operable network performance and network performance may include data carrying capacity, data transmission and/or reception speed, data transmission and/or reception latency, data transmission reliability, signal quality, data error/error correction rates, channel usage, interference rate, availability of network hardware, customer satisfaction rate, technician deployment rate, operational and/or maintenance cost, etc.

A network condition recognition module 202 may be configured to identify network conditions that may be affecting performance of the network hardware. Network conditions may be specific to particular locations of network hardware, such as local atmospheric conditions (e.g., temperature, wind, precipitation, etc.), operational network load, power availability, interfering signals from other local infrastructure, operational network condition, customer cable modem loss or degradation of services, time of day, network hardware site conditions (e.g., temperature), etc. As such, network conditions at different network hardware sites may vary. The network condition recognition module 202 may receive information indicating the network conditions from the Internet (e.g., communication network 140) and/or control systems of network hardware and/or network hardware sites (e.g., network hardware sites 142, 144, 146). The network condition recognition module 202 may identify and/or record network condition for one or more network hardware continuously, periodically, and/or episodically. For example, the network condition recognition module 202 may identify and/or record network condition individually for multiple network hardware at network hardware site. For another example, the network condition recognition module 202 may identify and/or record network condition collectively for multiple network hardware at network hardware site.

A network parameter selection module 204 may be configured with multiple functions depending on a criterion. The network parameter selection module 204 may be configured to determine whether one or more network conditions exist for one or more network hardware at a data structure (e.g., array, linked list, table, database, etc.) at a memory device (e.g., data storage device 152). The one or more network conditions may be the network conditions identified by the network condition recognition module 202.

For the one or more network conditions not existing for the one or more network hardware at the data structure, the network parameter selection module 204 may select two or more network parameters for configuring and testing the network hardware. Selecting the two or more network parameters may be implemented via various algorithms that may or may not consider prior selected network parameters, the one or more network conditions, and or prior results of testing the network hardware. For example, selecting the two or more network parameters may include random and/or pseudorandom selection of network parameters. For another example, selecting the two or more network parameters may include selection of network parameters by a predefined pattern. In some examples, selecting the two or more network parameters may include selecting two or more, including up to all, network parameters from a set of network parameters.

The network parameter selection module 204 may also select (or generate) values for setting the two or more network parameters for configuring and testing the network hardware. Selecting the values for setting the two or more network parameters may be implemented via various algorithms that may or may not consider prior selected values for network parameters, the one or more network conditions, and or prior results of testing the network hardware. For example, selecting values of the two or more network parameters may include random and/or pseudorandom selection of values for setting the network parameters. For another example, selecting values of the two or more network parameters may include selection of values for setting the network parameters by a predefined pattern. In some examples, values for setting the two or more network parameters may be selected from a set of values for respective network parameters. In some examples, the set of values for respective network parameters may be limited by regulation, technological limitations, etc.

For the one or more network conditions existing for the one or more network hardware at the data structure, the network parameter selection module 204 may select two or more network parameters for configuring and testing the network hardware that are associated with the one or more network conditions from the data structure. For multiple associations of the one or more network conditions with network parameters at the data structure, the selection may be made based on a classification value associated with the one or more network conditions and network parameters at the data structure. The classification value may indicate that the associated network parameters exhibit a greatest network hardware improvement for the one or more network conditions from among other network parameters associated with the one or more network conditions at the data structure.

The network parameter selection module 204 may also select (or generate) values for setting the two or more network parameters for configuring and testing the network hardware. The values for setting the two or more network parameters may be values associated with the one or more network conditions and the two or more network parameters at the data structure.

The network parameters may include any combination of profile management application thresholds for flat spectrum and/or roll-off spectrum, channel width, placement a channel in a spectrum, minimum and maximum modulation levels for a profile, number of segments per profile, number of profiles, forward error correction interleaver depth, etc.

A network parameter setting module 206 may be configured to electronically set the selected values for setting the two or more network parameters at the network hardware. For example, one or more registers, buffer values, electronic fuses (eFuses), switches, etc. may be set with values and/or selected to represent the selected values for setting the two or more network parameters at the network hardware. The selected values may be the values for the two or more network parameters selected by the network parameter selection module 204.

A network hardware testing module 208 may be configured to implement one or more tests of the network hardware. In some embodiments, the one or more tests of the network hardware may test the network hardware set with the selected values. In some embodiments, the one or more tests of the network hardware may also test additional network hardware at the same network site as the network hardware set with the selected values. In some embodiments, the one or more tests of the network hardware used to test the network hardware may be selected based on the network hardware set with the selected values. In some embodiments, the one or more tests of the network hardware used to test the network hardware may be standard tests implemented for the network hardware and/or the network hardware site regardless of the network hardware set with the selected values.

The network hardware tests may include data capacity tests, transmission and/or reception speed and/or latency tests, data transmission reliability tests, signal quality tests, data error/error correction rate tests, channel usage tests, interference rate tests, availability of network hardware tests, customer satisfaction rate tests, technician deployment rate tests, operational and/or maintenance cost tests, etc. The one or more tests of the network hardware may be implemented for an arbitrary duration, such as one or more seconds, minutes, hours, days, weeks, etc. The results of the one or more tests of the network hardware may be recorded over the duration. In some examples, the results of the one or more tests of the network hardware may be expressed as total accumulations and/or statistical calculations of events during the duration of the one or more tests of the network hardware.

The network hardware testing module 208 may store the results of the one or more tests of the network hardware, the one or more network conditions, the selected two or more network parameters and the respective selected values in association with each other in the data structure at the memory.

A network parameter machine learning model module 210 may be configured to train and implement a machine learning model configured for classifying the two or more network parameter settings for the network hardware for the one or more network conditions for at least achieving a performance threshold of the network hardware. The machine learning model may use the results of the one or more tests of the network hardware, the two or more network parameter settings, and the one or more network conditions as inputs to the machine learning model. In some embodiments, the performance threshold of the network hardware may be a value configured such that a classification value at least achieving the performance threshold of the network hardware indicates an improvement in performance of the network hardware as compared to previous classifications of different values of the two or more network parameter settings for the one or more network conditions.

The network parameter machine learning model module 210 may store information relating to the classifications in the data structure at the memory. For example, the network parameter machine learning model module 210 may store the classification value of the inputs to the machine learning model, the results of the one or more tests of the network hardware, the two or more network parameter settings, and/or the one or more network conditions in association with each other in the data structure at the memory. In some embodiments, the network parameter machine learning model module 210 may store the information relating to the classifications for classification values indicating improvement in performance of the network hardware as compared to previous classifications of different values of the two or more network parameter settings for the one or more network conditions.

The network parameter machine learning model module 210 may train the machine learning model using the results of the one or more tests of the network hardware, the two or more network parameter settings, and the one or more network conditions to continue to train the machine learning model even when being implemented. The continued training of the machine learning model may be implemented using any of various unsupervised training techniques, such as backpropagation, Boltzmann machine learning, Restricted Boltzmann machine learning, Hopefield machine learning, etc.

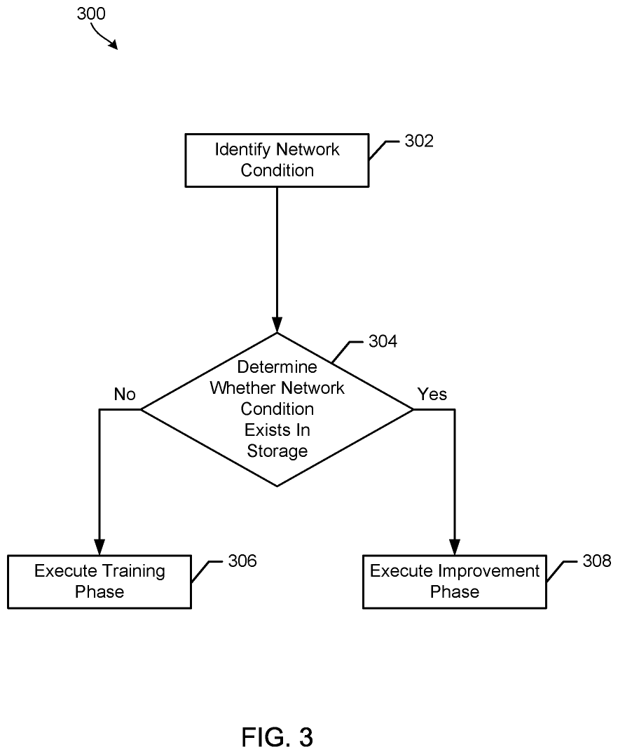

FIGS. 3, 4, 5, and 6 illustrate embodiment methods 300, 400, 500, 600 descriptions of which presented below are intended to be illustrative. In some embodiments, the methods 300, 400, 500, 600 may be accomplished with one or more additional operations not described, and/or without one or more of the operations discussed. Additionally, the order in which the operations of methods 300, 400, 500, 600 are illustrated in FIGS. 3, 4, 5, and 6 and described below is not intended to be limiting.

In some embodiment, methods 300, 400, 500, 600 may be implemented in a processing system (e.g., network hardware configuration processing system 200), having one or more processors, in conjunction with memory (e.g., data storage device 152). The processing system may include one or more device(s) executing some or all of the operations of the methods 300, 400, 500, 600 in response to instructions (e.g., self-improving network executable modules 202-210) stored electronically on an electronic storage medium (e.g., data storage device 152). The processing system may include one or more devices configured through hardware, firmware, and/or software to be specifically designed for execution of one or more of the operations of the methods 300, 400, 500, 600. For example, with reference to FIGS. 1 and 2, the operations of the methods 300, 400, 500, 600 may be performed by the processing system of the computing device (e.g., computing device 150).

FIG. 3 illustrates an embodiment method 300 for implementing self-improving networks (e.g., operational network 100) suitable for use with various embodiments. With reference to FIGS. 1-3, the network hardware configuration processing system 200, or processing system 200, may be configured with self-improving network executable modules 202-210 to implement operations of the method 300.

In block 302, the processing system 200 may identify one or more network conditions. The processing system 200 may receive information from the Internet (e.g., communication network 140) and control systems of one or more network hardware and/or network hardware sites 142, 144, 146 configured to indicate to the processing system one or more network conditions. The network conditions may include local atmospheric conditions (e.g., temperature, wind, precipitation, etc.), operational network load, power availability, interfering signals from other local infrastructure, operational network condition, customer cable modem loss or degradation of services, time of day, network hardware site conditions (e.g., temperature), etc. Additional network conditions may be considered and identified.

In block 304, the processing system 200 may determine whether the one or more network conditions exist at the data storage device 152. The processing system 200 may search the data structure at the data storage device 152 to determine whether an entry in the data structure includes the one or more network conditions.

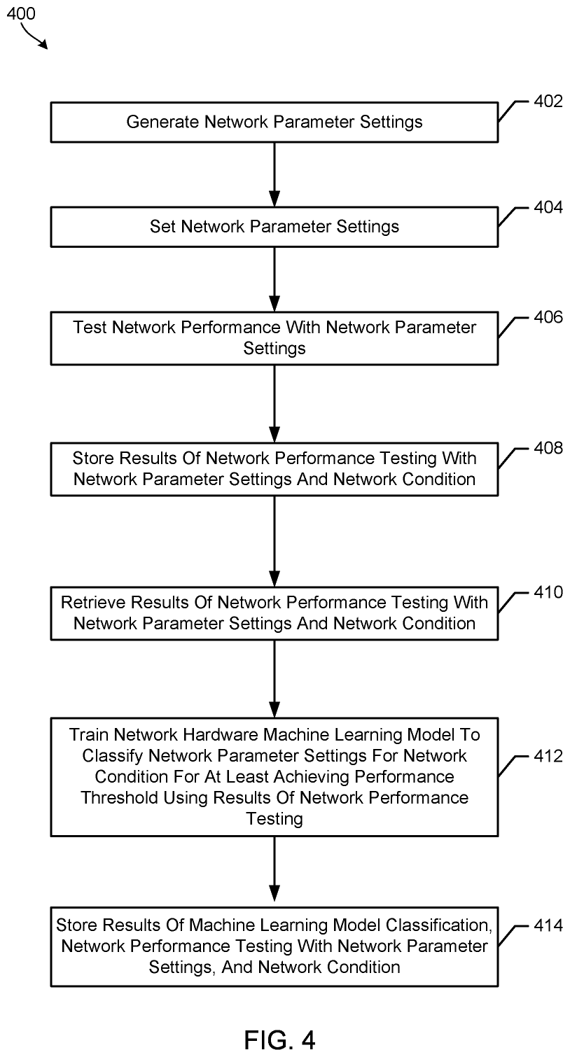

In response to determining that the one or more network conditions do(es) not exist at the data storage device 152 (i.e., determination block 304=“No”), the processing system 200 may execute a training phase in block 306. The training phase is described further herein for the method 400 with reference to FIG. 4.

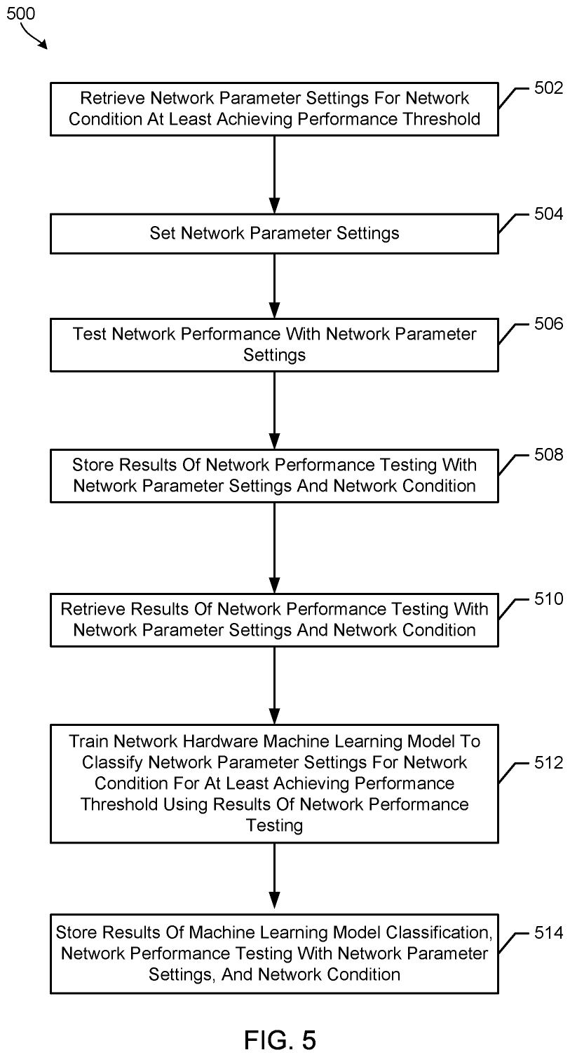

In response to determining that the one or more network conditions do(es) exist at the data storage device 152 (i.e., determination block 304=“Yes”), the processing system 200 may execute an improvement phase in block 308. The improvement phase is described further herein for the method 500 with reference to FIG. 5.

FIG. 4 illustrates an embodiment method 400 for implementing a training phase of self-improving networks (e.g., operational network 100) suitable for use with various embodiments. With reference to FIGS. 1-4, the network hardware configuration processing system 200, or processing system 200, may be configured with self-improving network executable modules 202-210 to implement operations of the method 400.

In block 402, the processing system 200 may generate two or more network parameter settings. The two or more network parameter settings may be for one or more network hardware. Generating two or more network parameter settings may at least include generating values for setting the two or more network parameters at the one or more network hardware. In some embodiments, generating the two or more network parameter settings may also include selecting the two or more network parameters.

The processing system 200 may select the two or more network parameters for configuring and testing the network hardware. Selecting the two or more network parameters may be implemented via various algorithms that may or may not consider prior selected network parameters, the one or more network conditions, and or prior results of testing the network hardware. For example, selecting the two or more network parameters may include random and/or pseudorandom selection of network parameters. For another example, selecting the two or more network parameters may include selection of network parameters by a predefined pattern. In some examples, selecting the two or more network parameters may include selecting two or more, including up to all, network parameters from a set of network parameters.

The processing system 200 may generate values for setting the at least two or more network parameters for configuring and testing the network hardware. Generating the values for setting the at least two or more network parameters may be implemented via various algorithms that may or may not consider prior selected values for network parameters, the one or more network conditions, and or prior results of testing the network hardware. For example, setting values of the at least two or more network parameters may include random and/or pseudorandom selection of values for setting the network parameters. As another example, setting values of the at least two or more network parameters may include selection of values for setting the network parameters by a predefined pattern. In some examples, values for setting the at least two or more network parameters may be selected from a set of values for respective network parameters. In some examples, the set of values for respective network parameters may be limited by regulation, technological limitations, etc.

In block 404, the processing system 200 may set the at least two or more network parameter settings. The processing system 200 may electronically set the values for setting the at least two or more network parameters at the network hardware. For example, one or more registers, buffer values, electronic fuses (eFuses), switches, etc. may be set with values and/or selected to represent the values for setting the at least two or more network parameters at the network hardware. The values may be the values for the two or more network parameters generated by the processing system 200 in block 402.

In block 406, the processing system 200 may test the first network performance having the values set for the two or more network parameter settings. Testing the first network performance may include implementing one or more tests of the network hardware. The one or more tests of the network hardware may test the network hardware set with the values for the two or more network parameters. In some embodiments, the one or more tests of the network hardware may also test additional network hardware at the same network site 142, 144, 146 as the network hardware set with the values. In some embodiments, the one or more tests of the network hardware used to test the network hardware may be selected based on the network hardware set with the values. In some embodiments, the one or more tests of the network hardware used to test the network hardware may be standard tests implemented for the network hardware and/or the network hardware site regardless of the network hardware set with the values.

The network hardware tests may include data capacity tests, transmission and/or reception speed and/or latency tests, data transmission reliability tests, signal quality tests, data error/error correction rate tests, channel usage tests, interference rate tests, availability of network hardware tests, customer satisfaction rate tests, technician deployment rate tests, operational and/or maintenance cost tests, etc. Other known network hardware tests may be included. The one or more tests of the network hardware may be implemented for an arbitrary duration, such as one or more seconds, minutes, hours, days, weeks, etc. The results of the one or more tests of the network hardware may be recorded over the duration. In some examples, the results of the one or more tests of the network hardware may be expressed as total accumulations and/or statistical calculations of events during the duration of the one or more tests of the network hardware.

In block 408, the processing system 200 may store the results of the one or more tests of the network performance, the one or more network conditions, the two or more network parameters and the respective values in association with each other in the data structure at the data storage device 152. The one or more network conditions may be the one or more network conditions identified in block 302 of the method 300 described herein with reference to FIG. 3.

In block 410, the processing system 200 may retrieve the results of the one or more tests of the network performance, the one or more network conditions, the two or more network parameters and the respective values stored in association with each other in the data structure at the data storage device 152.

In block 412, the processing system 200 may train the network parameter machine learning model (or machine learning model) for classifying network parameter settings for the network hardware based on the one or more network conditions for the network hardware for at least achieving a performance threshold of the network hardware. Training the machine learning model may be implemented using the results of the one or more tests of the network hardware, the two or more network parameter settings, and the one or more network conditions. Training of the machine learning model may be implemented using any of various unsupervised training techniques, such as backpropagation, Boltzmann machine learning, Restricted Boltzmann machine learning, Hopefield machine learning, etc.

The machine learning model may be trained for classifying the two or more network parameter settings for the network hardware for the one or more network conditions for at least achieving a performance threshold of the network hardware. The machine learning model may use the results of the one or more tests of the network hardware, the two or more network parameter settings, and the one or more network conditions as inputs to the machine learning model. In some embodiments, the performance threshold of the network hardware may be a value configured such that a classification value at least achieving the performance threshold of the network hardware indicates an improvement in performance of the network hardware as compared to previous classifications of different values of the two or more network parameter settings for the one or more network conditions.

In block 414, the processing system 200 may store information relating to the classifications in the data structure at the memory. For example, the processing system 200 may store the classification value of the inputs to the machine learning model, the results of the one or more tests of the network hardware, the two or more network parameter settings, and/or the one or more network conditions in association with each other in the data structure at the data storage device 152. In some embodiments, the processing system 200 may store the information relating to the classifications for classification values indicating improvement in performance of the network hardware as compared to previous classifications of different values of the two or more network parameter settings for the one or more network conditions.

FIG. 5 illustrates an embodiment method 500 for implementing an implementation phase of self-improving networks (e.g., operational network 100) suitable for use with various embodiments. With reference to FIGS. 1-5, the network hardware configuration processing system 200, or processing system 200, may be configured with self-improving network executable modules 202-210 to implement operations of the method 500.

In block 502, the processing device 200 may retrieve network parameter setting values for the network condition at least achieving the performance threshold of the network hardware from the data structure at the data storage device 152. The processing system 200 may search the data structure for the one or more network conditions and information associated with the one or more network conditions in the data structure, including the two or more network parameter setting values. In some embodiments, the data structure may include classification values as information associated with the one or more network conditions. The processing structure may also search for the classification value that indicates improvement in performance of the network hardware as compared to previous classifications of different values of the two or more network parameter settings for the one or more network conditions. The one or more network conditions may be the one or more network conditions identified in block 302 of the method 300 described herein with reference to FIG. 3.

In block 504, the processing system 200 may set the two or more network parameter settings. The processing system 200 may electronically set the values for setting the two or more network parameters at the network hardware. For example, one or more registers, buffer values, electronic fuses (eFuses), switches, etc. may be set with values and/or selected to represent the values for setting the two or more network parameters at the network hardware. The values may be the values for the two or more network parameters setting retrieved by the processing system 200 in block 502.

The processing system 200 may implement blocks 506-514 in a similar manner as blocks 406-414 of the method 400 described herein with reference to FIG. 4.

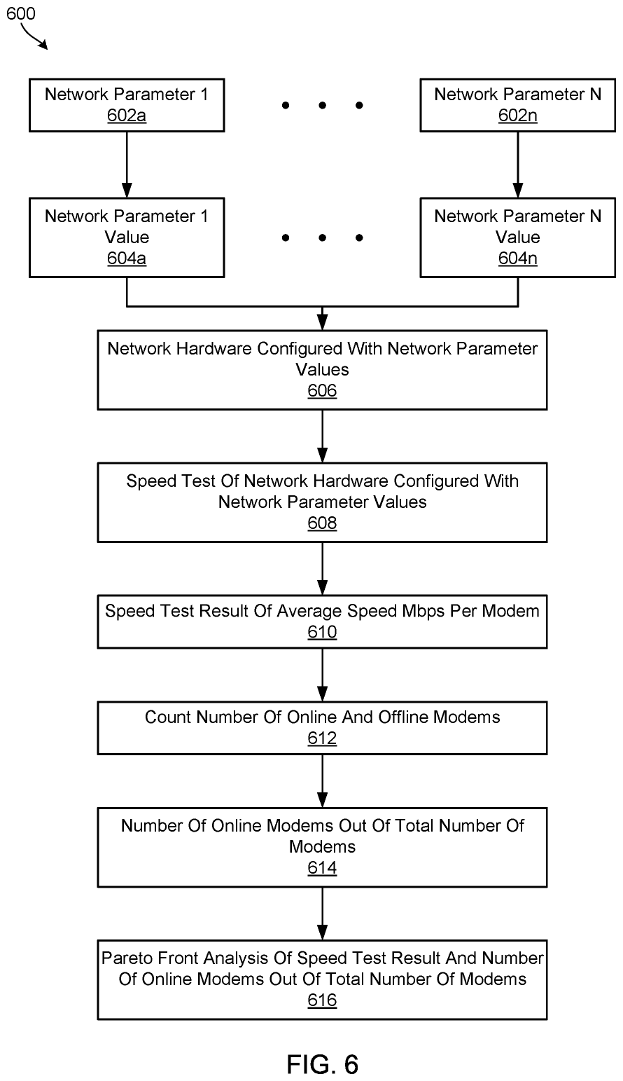

FIG. 6 illustrates an embodiment method 600 for implementing self-improving networks (e.g., operational network 100) suitable for use with various embodiments. With reference to FIGS. 1-6, the network hardware configuration processing system 200, or processing system 200, may be configured with self-improving network executable modules 202-210 to implement operations of the method 600.

The processing system 200 may implement self-improving networks for up to N network parameters 602a, 602n, where N is a number greater than 1. In some embodiments, the network parameters 602a, 602n for which the processing system implements self-improving networks may be preconfigured. In some embodiments, the network parameters 602a, 602n for which the processing system implements self-improving networks may be determined by the processing system 200. The processing system 200 may generate and/or retrieve up to N network parameter values 604a, 604n. The network parameter values 604a, 604n may be one value for each network parameter 602a, 602n.

The processing system 200 may set the network parameter values 604a through 604n for the network parameters 602a through 602n at the network hardware and/or network hardware site 142, 144, 146. When the network parameter values 604a through 604n are set, the network hardware is configured with the network parameter values 606.

The processing system 200 may implement a test of the network hardware configured with the network parameter values 606. For example, the test may be an implementation of a speed test of the network hardware is configured with the network parameter values 608. The test of the network hardware configured with the network parameter values 606 may produce speed test results of an average speed (e.g., Mbps) of per modem 610 associated with the network hardware configured with the network parameter values 606. The test of the network hardware configured with the network parameter values 606 may produce a count of a number of online and offline modems 612 associated with the network hardware configured with the network parameter values 606. The processing system 200 may use the count of modems to calculate representation of online modems out of all of the counted modems 614. For example, the representation of online modems out of all of the counted modems 614 may be a percentage, ratio, reciprocal value, etc.

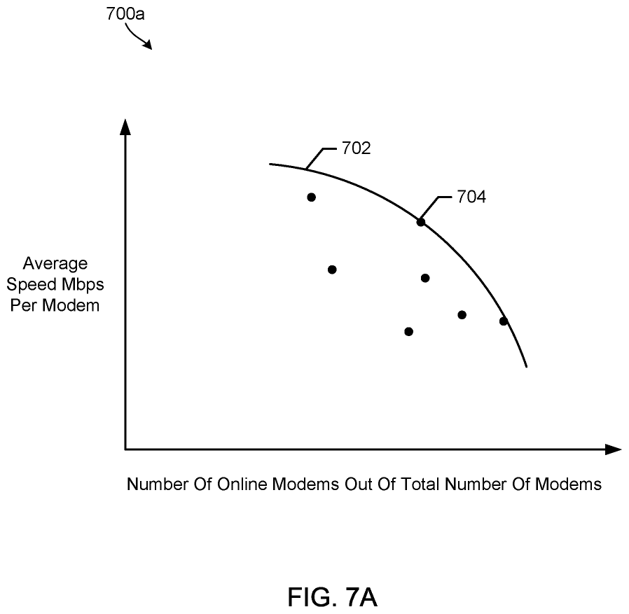

The processing system 200 may perform an analysis of the speed test results of an average speed of per modem 610 in relation to the representation of online modems out of all of the counted modems 614. The analysis may involve a Pareto front analysis of the speed test results of an average speed of per modem in relation to the representation of online modems out of all of the counted modems 616, examples of which are illustrated in the graph diagrams shown in FIGS. 7A and 7B.

The processing system 200 may be configured to execute the machine learning model to implement the Pareto front analysis of the speed test results of an average speed of per modem in relation to the representation of online modems out of all of the counted modems 616. For example, the machine learning algorithm may be configured to classify the network parameter values 604a, 604n that at least achieve performance improvement over previous network parameter values according to the Pareto front analysis 616.

In the example illustrated in the graph 700a in FIG. 7A, a Pareto front 702 based on tested network parameter values may be an indicator of performance improvement. For example, a data 704 of a comparison of the speed test results of an average speed of per modem 610 in relation to the representation of online modems out of all of the counted modems 614 fits closer to the Pareto front 702 than other data, the data 704 is indicative of performance improvement.

Similarly, in the example illustrated in the graph 700b in FIG. 7B, the data 710 of a comparison of the speed test results of an average speed of per modem 610 in relation to the representation of online modems out of all of the counted modems 614 a closest distance 712 to the origin than other data is indicative of performance improvement. The processing system 200 implementing the machine learning model may implement the Pareto front analysis of the speed test results of an average speed of per modem in relation to the representation of online modems out of all of the counted modems 616 classifying the data 704, 710 and/or the related network parameter values 604a, 604n as improving performance of the network hardware.

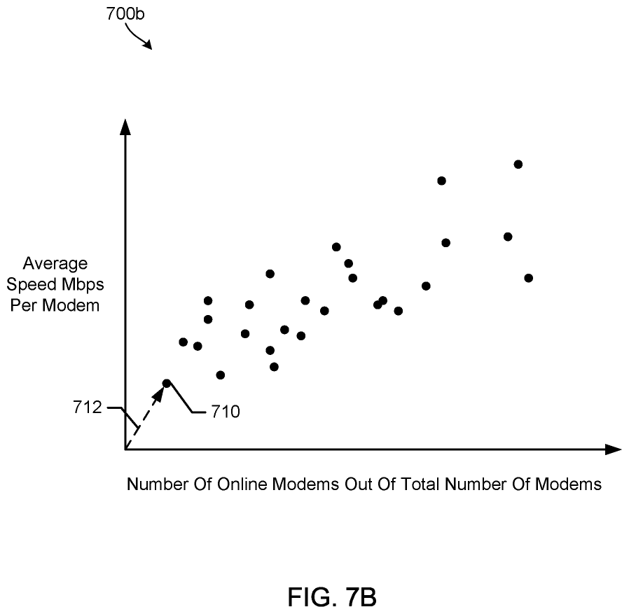

The various embodiments (including, but not limited to, embodiments discussed above with reference to FIGS. 1-7B) may be implemented for any of a variety network hardware, as illustrated in FIG. 8. With reference to FIGS. 1-8, a network hardware 800 may include a processor 801 coupled to volatile memory 802. The network hardware 800 may also include one or more connections or port(s) 808 coupled to the processor 801 and configured to input and/or output data from the port(s) 808. The network hardware 800 may also include one or more network transceivers 805, with one or more antenna 806 coupled thereto, providing a network access port, coupled to the processor 801 for establishing wired or wireless network interface connections with a communication network, such as a local area network coupled to other computing devices and routers/switches, the Internet, the public switched telephone network, and/or a cellular network (e.g., CDMA, TDMA, GSM, PCS, 3G, 4G, LTE, or any other type of cellular network). The network hardware 800 may transmit and/or receive data or other communications via the network transceiver 805 and/or the port(s) 808.

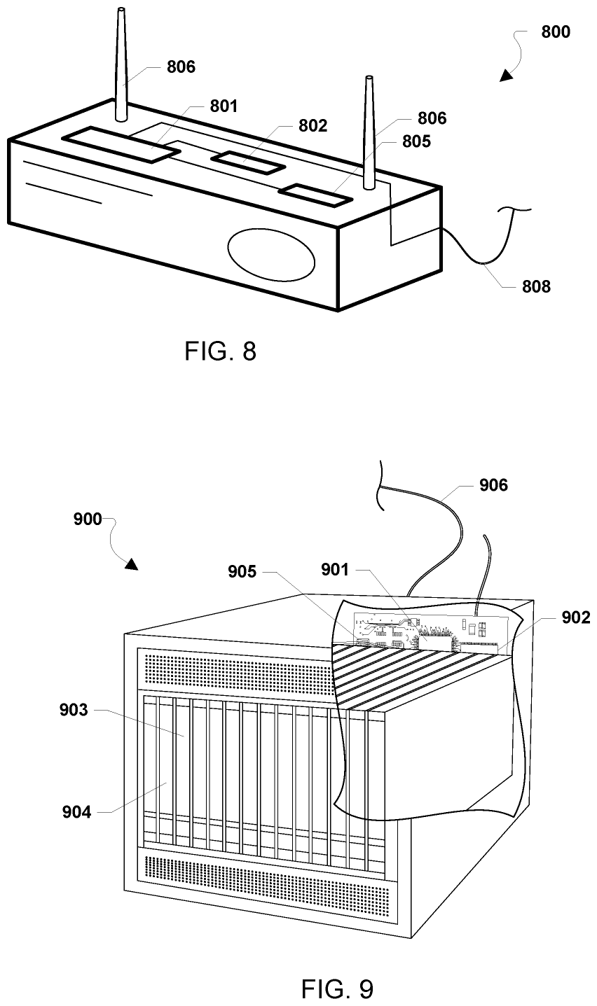

Various embodiments (including, but not limited to, embodiments discussed above with reference to FIGS. 1-7B) may be implemented on any of a variety of commercially available servers (e.g., computing device 150), which may be connected to network hardware (e.g., network hardware 800) at one or more network hardware sites (e.g., network hardware sites 142, 144, 146) such as the server 900 illustrated in FIG. 9. The server 900 may include a processor 901 coupled to volatile memory 902 and a large capacity nonvolatile memory, such as a disk drive 903 (e.g., data storage device 152). The server 900 may also include a floppy disc drive, compact disc (CD) or DVD disc drive 904 coupled to the processor 901. The server 900 may also include network access ports 906 coupled to the processor 901 for establishing data connections with a network connection circuit 905 and a communication network (e.g., communication) coupled to other communication system network elements.

The processors 801, 901 may be any one or more programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 801, 901. The processors 801, 901 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 801, 901 including internal memory or removable memory plugged into the device and memory within the processors 801, 901 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a module may be, but is not limited to, a process running on a processor, a processor, an object, an executable, a thread of execution, a program, or a computer. By way of illustration, both an application running on a computing device and the computing device may be referred to as a module. One or more modules may reside within a process or thread of execution and a module may be localized on one processor or core or distributed between two or more processors or cores. In addition, these modules may execute from various non-transitory processor-readable storage media having various instructions or data structures stored thereon. Modules may communicate by way of local or remote processes, function or procedure calls, electronic signals, data packets, memory read/writes, and other known network, computer, processor, or process related communication methodologies.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable storage media. Additionally, the operations of a method or algorithm may reside as one or any combination or set of codes and/or instructions on a non-transitory server-readable, processor-readable medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for self-improving networks implemented by a processing system, comprising:
setting at least two first network parameter settings for a first network hardware deployed in an operable network;
testing performance of the first network hardware having the at least two first network parameter settings;
storing results of testing the first network hardware having the at least two first network parameter settings and at least one first network condition of the first network hardware in association with each other;
training a machine learning model for classifying network parameter settings for the first network hardware based on one or more network conditions for the first network hardware for at least achieving a performance threshold of the first network hardware using the stored results of testing the first network hardware having the at least two first network parameter settings, the at least two first network parameter settings, and the at least one first network condition as training inputs to the machine learning model; and
storing at least a first result of the machine learning model classifying the network parameter settings for the first network hardware based on the one or more network conditions for the first network hardware for at least achieving the performance threshold of the first network hardware in association with the at least two first network parameter settings and the at least one first network condition of the first network hardware.

2. The method of claim 1, wherein setting the at least two first network parameter settings for the first network hardware comprises setting the at least two first network parameter settings for the first network hardware for the at least one first network condition using the at least two first network parameter settings for the first network hardware stored in association with the at least one first network condition and the first result of the machine learning model classifying the network parameter settings for the first network hardware based on the one or more network conditions for the first network hardware for at least achieving the performance threshold of the first network hardware.

3. The method of claim 1, further comprising:
setting at least two second network parameter settings for the first network hardware;
testing performance of the first network hardware having the at least two second network parameter settings;
storing results of testing the first network hardware having the at least two second network parameter settings, the at least two second network parameter settings, and at least one second network condition of the first network hardware in association with each other;
training the machine learning model for classifying the network parameter settings for the first network hardware based on the one or more network conditions for the first network hardware for at least achieving the performance threshold of the first network hardware using the results of testing the first network hardware having the at least two second network parameter settings, the at least two second network parameter settings, and the at least one second network condition as training inputs to the machine learning model; and
storing at least a second result of the machine learning model classifying the network parameter settings for the first network hardware based on the one or more network conditions for the first network hardware for at least achieving the performance threshold of the first network hardware in association with the at least two second network parameter settings and the at least one second network condition of the first network hardware.

4. The method of claim 3, wherein the at least two second network parameter settings include at least one of the at least two first network parameter settings, and the at least one second network condition includes at least one of the at least one first network condition.

5. The method of claim 1, further comprising:
setting at least two second network parameter settings for a second network hardware deployed in the operable network and that is different from the first network hardware;
testing performance of the second network hardware having the at least two second network parameter settings;
storing results of testing the second network hardware having the at least two second network parameter settings, the at least two second network parameter settings, and at least one second network condition of the second network hardware in association with each other;
training the machine learning model for classifying network parameter settings for the second network hardware based on the one or more network conditions for the second network hardware for at least achieving a performance threshold of the second network hardware using the results of testing the second network hardware having the at least two second network parameter settings, the at least two second network parameter settings, and the at least one second network condition as training inputs to the machine learning model; and
storing at least a second result of the machine learning model classifying the network parameter settings for the second network hardware based on the one or more network conditions for the second network hardware for at least achieving the performance threshold of the second network hardware in association with the at least two second network parameter settings and the at least one second network condition of the second network hardware.

6. The method of claim 1, wherein testing the performance of the first network hardware having the at least two first network parameter settings comprises testing throughput speed of the first network hardware having the at least two first network parameter settings.

7. The method of claim 1, wherein the performance threshold of the first network hardware is configured for indicating how the first result of the machine learning model classifying the network parameter settings for the first network hardware based on the one or more network conditions for the first network hardware for at least achieving the performance threshold of the first network hardware compares with at least one other result of the machine learning model classifying the network parameter settings for the first network hardware based on the one or more network conditions for the first network hardware for at least achieving the performance threshold of the first network hardware.

8. A computing device, comprising a processing system coupled to the memory and configured with processing system-executable instructions to cause the processing system to perform operations, comprising:
setting at least two first network parameter settings for a first network hardware deployed in an operable network;
testing performance of the first network hardware having the at least two first network parameter settings;
storing results of testing the first network hardware having the at least two first network parameter settings and at least one first network condition of the first network hardware in association with each other;
training a machine learning model for classifying network parameter settings for the first network hardware based on one or more network conditions for the first network hardware for at least achieving a performance threshold of the first network hardware using the stored results of testing the first network hardware having the at least two first network parameter settings, the at least two first network parameter settings, and the at least one first network condition as training inputs to the machine learning model; and
storing at least a first result of the machine learning model classifying the network parameter settings for the first network hardware based on the one or more network conditions for the first network hardware for at least achieving the performance threshold of the first network hardware in association with the at least two first network parameter settings and the at least one first network condition of the first network hardware.

9. The computing device of claim 8, wherein the processing system is configured with processing system-executable instructions configured to cause the processing system to perform operations such that setting the at least two first network parameter settings for the first network hardware comprises setting the at least two first network parameter settings for the first network hardware for the at least one first network condition using the at least two first network parameter settings for the first network hardware stored in association with the at least one first network condition and the first result of the machine learning model classifying the network parameter settings for the first network hardware based on the one or more network conditions for the first network hardware for at least achieving the performance threshold of the first network hardware.

10. The computing device of claim 8, wherein the processing system is configured with processing system-executable instructions configured to cause the processing system to perform operations further comprising:
setting at least two second network parameter settings for the first network hardware;
testing performance of the first network hardware having the at least two second network parameter settings;
storing results of testing the first network hardware having the at least two second network parameter settings, the at least two second network parameter settings, and at least one second network condition of the first network hardware in association with each other;
training the machine learning model for classifying the network parameter settings for the first network hardware based on the one or more network conditions for the first network hardware for at least achieving the performance threshold of the first network hardware using the results of testing the first network hardware having the at least two second network parameter settings, the at least two second network parameter settings, and the at least one second network condition as training inputs to the machine learning model; and
storing at least a second result of the machine learning model classifying the network parameter settings for the first network hardware based on the one or more network conditions for the first network hardware for at least achieving the performance threshold of the first network hardware in association with the at least two second network parameter settings and the at least one second network condition of the first network hardware.

11. The computing device of claim 10, wherein the processing system is configured with processing system-executable instructions configured to cause the processing system to perform operations such that the at least two second network parameter settings include at least one of the at least two first network parameter settings, and the at least one second network condition includes at least one of the at least one first network condition.

12. The computing device of claim 8, wherein the processing system is configured with processing system-executable instructions configured to cause the processing system to perform operations further comprising:
setting at least two second network parameter settings for a second network hardware deployed in the operable network and that is different from the first network hardware;
testing performance of the second network hardware having the at least two second network parameter settings;
storing results of testing the second network hardware having the at least two second network parameter settings, the at least two second network parameter settings, and at least one second network condition of the second network hardware in association with each other;
training the machine learning model for classifying network parameter settings for the second network hardware based on the one or more network conditions for the second network hardware for at least achieving a performance threshold of the second network hardware using the results of testing the second network hardware having the at least two second network parameter settings, the at least two second network parameter settings, and the at least one second network condition as training inputs to the machine learning model; and
storing at least a second result of the machine learning model classifying the network parameter settings for the second network hardware based on the one or more network conditions for the second network hardware for at least achieving the performance threshold of the second network hardware in association with the at least two second network parameter settings and the at least one second network condition of the second network hardware.

13. The computing device of claim 8, wherein the processing system is configured with processing system-executable instructions configured to cause the processing system to perform operations such that testing the performance of the first network hardware having the at least two first network parameter settings comprises testing throughput speed of the first network hardware having the at least two first network parameter settings.

14. The computing device of claim 8, wherein the processing system is configured with processing system-executable instructions configured to cause the processing system to perform operations such that the performance threshold of the first network hardware is configured for indicating how the first result of the machine learning model classifying the network parameter settings for the first network hardware based on the one or more network conditions for the first network hardware for at least achieving the performance threshold of the first network hardware compares with at least one other result of the machine learning model classifying the network parameter settings for the first network hardware based on the one or more network conditions for the first network hardware for at least achieving the performance threshold of the first network hardware.

15. A computing device, comprising:
means for setting at least two first network parameter settings for a first network hardware deployed in an operable network;
means for testing performance of the first network hardware having the at least two first network parameter settings;
means for storing results of testing the first network hardware having the at least two first network parameter settings and at least one first network condition of the first network hardware in association with each other;
means for training a machine learning model for classifying network parameter settings for the first network hardware based on one or more network conditions for the first network hardware for at least achieving a performance threshold of the first network hardware using the stored results of testing the first network hardware having the at least two first network parameter settings, the at least two first network parameter settings, and the at least one first network condition as training inputs to the machine learning model; and
means for storing at least a first result of the machine learning model classifying the network parameter settings for the first network hardware based on the one or more network conditions for the first network hardware for at least achieving the performance threshold of the first network hardware in association with the at least two first network parameter settings and the at least one first network condition of the first network hardware.

16. The computing device of claim 15, wherein the means for setting the at least two first network parameter settings for the first network hardware comprises means for setting the at least two first network parameter settings for the first network hardware for the at least one first network condition using the at least two first network parameter settings for the first network hardware stored in association with the at least one first network condition and the first result of the machine learning model classifying the network parameter settings for the first network hardware based on the one or more network conditions for the first network hardware for at least achieving the performance threshold of the first network hardware.

17. The computing device of claim 15, further comprising:
means for setting at least two second network parameter settings for the first network hardware;
means for testing performance of the first network hardware having the at least two second network parameter settings;
means for storing results of testing the first network hardware having the at least two second network parameter settings, the at least two second network parameter settings, and at least one second network condition of the first network hardware in association with each other;
means for training the machine learning model for classifying the network parameter settings for the first network hardware based on the one or more network conditions for the first network hardware for at least achieving the performance threshold of the first network hardware using the results of testing the first network hardware having the at least two second network parameter settings, the at least two second network parameter settings, and the at least one second network condition as training inputs to the machine learning model; and
means for storing at least a second result of the machine learning model classifying the network parameter settings for the first network hardware based on the one or more network conditions for the first network hardware for at least achieving the performance threshold of the first network hardware in association with the at least two second network parameter settings and the at least one second network condition of the first network hardware.

18. The computing device of claim 17, wherein the at least two second network parameter settings include at least one of the at least two first network parameter settings, and the at least one second network condition includes at least one of the at least one first network condition.

19. The computing device of claim 15, further comprising:
means for setting at least two second network parameter settings for a second network hardware deployed in the operable network and that is different from the first network hardware;
means for testing performance of the second network hardware having the at least two second network parameter settings;
means for storing results of testing the second network hardware having the at least two second network parameter settings, the at least two second network parameter settings, and at least one second network condition of the second network hardware in association with each other;
means for training the machine learning model for classifying network parameter settings for the second network hardware based on the one or more network conditions for the second network hardware for at least achieving a performance threshold of the second network hardware using the results of testing the second network hardware having the at least two second network parameter settings, the at least two second network parameter settings, and the at least one second network condition as training inputs to the machine learning model; and
means for storing at least a second result of the machine learning model classifying the network parameter settings for the second network hardware based on the one or more network conditions for the second network hardware for at least achieving the performance threshold of the second network hardware in association with the at least two second network parameter settings and the at least one second network condition of the second network hardware.

20. The computing device of claim 15, wherein the means for testing the performance of the first network hardware having the at least two first network parameter settings comprises means for testing throughput speed of the first network hardware having the at least two first network parameter settings.

21. The computing device of claim 15, wherein the performance threshold of the first network hardware is configured for indicating how the first result of the machine learning model classifying the network parameter settings for the first network hardware based on the one or more network conditions for the first network hardware for at least achieving the performance threshold of the first network hardware compares with at least one other result of the machine learning model classifying the network parameter settings for the first network hardware based on the one or more network conditions for the first network hardware for at least achieving the performance threshold of the first network hardware.

22. A non-transitory processing system-readable medium having stored thereon processing system-executable instructions configured to cause a processing system to perform operations comprising:
setting at least two first network parameter settings for a first network hardware deployed in an operable network;
testing performance of the first network hardware having the at least two first network parameter settings;
storing results of testing the first network hardware having the at least two first network parameter settings and at least one first network condition of the first network hardware in association with each other;
training a machine learning model for classifying network parameter settings for the first network hardware based on one or more network conditions for the first network hardware for at least achieving a performance threshold of the first network hardware using the stored results of testing the first network hardware having the at least two first network parameter settings, the at least two first network parameter settings, and the at least one first network condition as training inputs to the machine learning model; and
storing at least a first result of the machine learning model classifying the network parameter settings for the first network hardware based on the one or more network conditions for the first network hardware for at least achieving the performance threshold of the first network hardware in association with the at least two first network parameter settings and the at least one first network condition of the first network hardware.

23. The non-transitory processor-readable medium of claim 22, wherein the stored processing system-executable instructions are configured to cause the processing system to perform operations such that setting the at least two first network parameter settings for the first network hardware comprises setting the at least two first network parameter settings for the first network hardware for the at least one first network condition using the at least two first network parameter settings for the first network hardware stored in association with the at least one first network condition and the first result of the machine learning model classifying the network parameter settings for the first network hardware based on the one or more network conditions for the first network hardware for at least achieving the performance threshold of the first network hardware.

24. The non-transitory processor-readable medium of claim 22, wherein the stored processing system-executable instructions are configured to cause the processing system to perform operations further comprising:
setting at least two second network parameter settings for the first network hardware;
testing performance of the first network hardware having the at least two second network parameter settings;
storing results of testing the first network hardware having the at least two second network parameter settings, the at least two second network parameter settings, and at least one second network condition of the first network hardware in association with each other;
training the machine learning model for classifying the network parameter settings for the first network hardware based on the one or more network conditions for the first network hardware for at least achieving the performance threshold of the first network hardware using the results of testing the first network hardware having the at least two second network parameter settings, the at least two second network parameter settings, and the at least one second network condition as training inputs to the machine learning model; and
storing at least a second result of the machine learning model classifying the network parameter settings for the first network hardware based on the one or more network conditions for the first network hardware for at least achieving the performance threshold of the first network hardware in association with the at least two second network parameter settings and the at least one second network condition of the first network hardware.

25. The non-transitory processor-readable medium of claim 24, wherein the stored processing system-executable instructions are configured to cause the processing system to perform operations such that the at least two second network parameter settings include at least one of the at least two first network parameter settings, and the at least one second network condition includes at least one of the at least one first network condition.

26. The non-transitory processor-readable medium of claim 22, wherein the stored processing system-executable instructions are configured to cause the processing system to perform operations further comprising:
setting at least two second network parameter settings for a second network hardware deployed in the operable network and that is different from the first network hardware;
testing performance of the second network hardware having the at least two second network parameter settings;
storing results of testing the second network hardware having the at least two second network parameter settings, the at least two second network parameter settings, and at least one second network condition of the second network hardware in association with each other;
training the machine learning model for classifying network parameter settings for the second network hardware based on the one or more network conditions for the second network hardware for at least achieving a performance threshold of the second network hardware using the results of testing the second network hardware having the at least two second network parameter settings, the at least two second network parameter settings, and the at least one second network condition as training inputs to the machine learning model; and
storing at least a second result of the machine learning model classifying the network parameter settings for the second network hardware based on the one or more network conditions for the second network hardware for at least achieving the performance threshold of the second network hardware in association with the at least two second network parameter settings and the at least one second network condition of the second network hardware.

27. The non-transitory processor-readable medium of claim 22, wherein the stored processing system-executable instructions are configured to cause the processing system to perform operations such that testing the performance of the first network hardware having the at least two first network parameter settings comprises testing throughput speed of the first network hardware having the at least two first network parameter settings.

28. The non-transitory processor-readable medium of claim 22, wherein the stored processing system-executable instructions are configured to cause the processing system to perform operations such that the performance threshold of the first network hardware is configured for indicating how the first result of the machine learning model classifying the network parameter settings for the first network hardware based on the one or more network conditions for the first network hardware for at least achieving the performance threshold of the first network hardware compares with at least one other result of the machine learning model classifying the network parameter settings for the first network hardware based on the one or more network conditions for the first network hardware for at least achieving the performance threshold of the first network hardware.
